(19) United States
(12) Patent Application Publication
(10) Pub. No.: US 2010/0098362 A1
(43) Pub. Date: Apr. 22, 2010

(54) Instrumented Roller Bearing Device

(76) Inventors: Sylvain Chaussat, Tours (FR); Olivier Joubert, Fondettes (FR); Laeticia Petit, Neuille-Pont-Pierre (FR)

Correspondence Address: SKF USA Inc., 890 Forty Foot Road, PO Box 332, Kulpsville, PA, 19443, US

(21) Appl. No.: 12/226,467

(22) PCT Filed: Feb. 27, 2007
(86) PCT No.: PCT/FR2007/000350

§ 371 Date: Oct. 16, 2008

(30) Foreign Application Priority Data
Apr. 20, 2006 (FR) 0603498
Oct. 18, 2006 (FR) 0654351

(51) Int. Cl. F16C 32/00

(52) U.S. Cl. 384/448

(57) ABSTRACT

The instrumented rolling bearing device comprises a rotating ring 5, a non-rotating ring 4, and a detection assembly 3 equipped with a sensor unit 11 comprising an external annular portion 11b and a means of axially retaining the sensor unit on the non-rotating ring positioned on the external annular portion 11b. The outside diameter of the external annular portion 11b is smaller than the inside diameter of a frontal radial surface 4b of the non-rotating ring.

The invention relates to the field of instrumented rolling bearings intended to detect rotation parameters, for example angular velocity, displacement, etc. of an element secured to the rotating ring of the bearing.

As is known per se, instrumented rolling bearings such as this comprise the actual bearing to which there is attached a sensor unit comprising a sensor that interacts with an encoder element fixed to a rotating part of the bearing or to a component connected to the rotating ring of the rolling bearing.

The sensor unit is often made of an injection-molded plastic and houses the sensor or sensors which is or are electrically connected to a signal-processing printed circuit. The sensor unit often comprises a connector intended for the output of signals emitted by the instrumented rolling bearing to an external signal exploiting system.

In order to attach the sensor unit to the non-rotating ring of the rolling bearing, a ring of hooked tabs or a continuous annular rib that fits into a groove of said non-rotating ring is generally provided. For fuller details, reference may, for example, be made to patent application FR-A-2 723 621 which describes an instrumented rolling bearing provided with a sensor unit such as this.

This device has the particular disadvantage of comprising a sensor unit which is provided with a region that bears axially against a frontal radial surface of the non-rotating ring of the rolling bearing. This may prove to be particularly troublesome, particularly in the case of small-sized rolling bearings where this frontal surface is used as a reference surface that bears against a shoulder or some other surface of an associated housing.

It is an object of the invention to overcome these disadvantages.

Another object of the invention is to propose an instrumented rolling bearing device that is particularly easy to fit, simple and economic.

A further object of the present invention is to provide an instrumented rolling bearing device in which the risk of the constituent parts thereof becoming detached from one another is limited.

The instrumented rolling bearing device comprises a rotating ring, a non-rotating ring, and a detection assembly equipped with a sensor unit comprising an external annular portion and a means of axially retaining the sensor unit on the non-rotating ring positioned on the external annular portion. The outside diameter of the external annular portion is smaller than the inside diameter of a frontal radial surface of the non-rotating ring.

This then yields a rolling bearing which, after the sensor unit has been fitted, comprises a non-rotating ring the radial frontal surface of which is entirely unencumbered.

In other words, the external annular portion of the sensor unit has no element situated radially between an internal edge and an external edge of the non-rotating ring, and axially on the outside of the bearing. Thus, the frontal lateral surface of the non-rotating ring remains completely unencumbered, making the rolling bearing far easier to fit inside the associated housing.

In one embodiment, the means of axial retention comprises a circumferentially continuous radial rib that comes into frictional contact with a groove belonging to the non-rotating ring.

In one embodiment, the rib is chamfered at an angle smaller than or equal to that of a groove entry chamfer. This then makes it easier for the rib to enter the rolling bearing, and more particularly to enter the groove in the non-rotating ring, and also makes it far easier to fit the sensor unit.

In one embodiment, the external annular portion comprises a frontal surface at least part of which is in frictional contact with the groove and a retaining surface at least part of which is in frictional contact with the groove. Said surfaces form means of holding the sensor unit in position on the non-rotating ring.

Thus, it becomes possible to secure the sensor unit relative to the non-rotating ring in the axial, radial and circumferential directions without any need to provide any additional component. In other words, the frontal surface of the external annular portion and the rib together constitute the means of immobilizing the sensor unit and the non-rotating ring relative to one another.

In one embodiment, the sensor unit is provided with an internal annular portion that forms a narrow passage with a frontal radial surface of the rotating ring, and with a radial portion positioned between the internal annular portion and the external annular portion. The rib, the radial portion and the internal and external annular portions delimit a sealed annular space for a sensor.

In one embodiment, the non-rotating ring comprises an additional groove identical to the groove associated with the rib and in which a sealing plate is mounted.

In one embodiment, the sensor unit comprises a connector and at least one positioning element inside which the connector is mounted. The positioning element extends axially with respect to a radial portion of the sensor unit, in the direction away from the rings.

In one embodiment, the positioning element has an outside diameter smaller than the inside diameter of the frontal radial surface of the non-rotating ring.

In one embodiment, the sensor unit comprises a printed circuit board, a radial portion of said sensor unit forming a partition being positioned between the connector and the printed circuit board.

In one embodiment, the sensor unit is made of polybutylene tetraphthalate, preferably filled with mineral fibers, for example glass fibers.

The instrumented rolling bearing device comprises a rotating ring and a non-rotating ring which are concentric and each equipped with a raceway, a row of rolling elements positioned between the raceways, and a detection assembly equipped with a sensor unit. The detection assembly comprises an attached connector equipped with pins and with a rear face in contact with a first face of the sensor unit, and a printed circuit board in contact with a second face of the sensor unit, on the opposite side to the first. The pins of the connector pass through holes made in the printed circuit board and in the sensor unit between the first and second faces. Spots of solder material provide the axial connection between the connector and the printed circuit board and keep the connector, the sensor unit and the printed circuit board in axial contact.

The printed circuit board, the sensor unit and the connector are extremely simple to fit, the connector and the printed circuit board can be used for rolling bearings of different diameters. The rolling bearing itself may be of the standard, deep-groove type, that can be mass-produced in great numbers. This then yields a multi-function product of modular and simple structure that uses standardized elements.

In one embodiment of the invention, the sensor unit comprises a partition positioned between the connector and the printed circuit board. The axial connection between the connector and the printed circuit board thus acts like a rivet holding the connector, the partition of the sensor unit and the printed circuit board together. The printed circuit board may be in contact with an internal radial face of the partition.

In one embodiment, the printed circuit board supports at least one sensor intended to interact with an encoder element fixed to the rotating ring. As an alternative, the encoder element may be fixed to a rotating component secured to the rotating ring.

In one embodiment, the sensor unit comprises a radial annular portion, an external axial annular portion and an internal axial annular portion. The radial annular portion is positioned between the external and internal axial annular portions. The sensor unit in axial section is C-shaped. The radial annular portion may form the partition positioned between the connector and the printed circuit board. The sensor unit may be formed as one piece, for example by injection-molding.

In one embodiment of the invention, the sensor unit comprises a tab for axially retaining the printed circuit board.

In one embodiment, the sensor unit comprises at least one element for positioning of the connector, said positioning element being positioned on the first face of the sensor unit. This then makes the connector and the sensor unit easier to assemble.

In one embodiment, the diameter of the sensor unit is smaller than the large diameter of the radial lateral face of the ring supporting the sensor unit. The overall radial size of the detection assembly remains small.

In one embodiment, the sensor unit comprises at least one stud for retaining the printed circuit board, said stud originating out of an internal wall of the sensor unit and extending radially to come into contact with the printed circuit board. This then makes the printed circuit board and the sensor unit easier to pre-assemble. The sensor unit may comprise two printed circuit board retaining studs extending radially, one of them inward and the other one outward, to come into contact with the printed circuit board.

In one embodiment, at least one opening is formed in one wall of the sensor unit to improve the radial flexibility of the sensor unit. The opening may be made near the stud or studs to make it easier to move the printed circuit board axially relative to the sensor unit when these two elements are being pre-assembled.

The invention also relates to a method of assembling the instrumented rolling bearing comprising a rotating ring and a non-rotating ring which are concentric and each equipped with a raceway, a row of rolling elements positioned between the raceways, and a detection assembly equipped with a sensor unit.

A pin-type connector is attached, the pins of the connector passing through the holes formed in the sensor unit between two opposing faces of the sensor unit, a rear face of the connector being in contact with a first face of the sensor unit, a printed circuit board is attached in contact with a second face of the sensor unit, the pins of the connector passing through holes formed in the printed circuit board, and the connector and the printed circuit board are axially connected by spots of solder material keeping the connector, the sensor unit and the printed circuit board in axial contact.

This then yields a detection assembly comprising numerous standard elements independent of the type and diameter of the rolling bearing and which can be fixed onto the rolling bearing by push fitting in an axial movement that is relatively easy to automate.

In one embodiment, the printed circuit board is introduced into the sensor unit with an axial movement, this causing the temporary parting of studs that retain the sensor unit and that are capable of moving radially, and then of returning to their initial position, thus holding the printed circuit board relative to the sensor unit before the soldered connections are made.

In one embodiment, the radial portion of the sensor unit comprises, on its second face, at least one rib. Said rib stiffens the sensor unit and allows a relatively coarse initial positioning of the printed circuit board in the region in which it is to be mounted. It is of course possible to provide a higher number of ribs running angularly and/or radially. The ribs may also be chamfered to make it easier for the printed circuit board to be positioned angularly toward its definitive position.

The invention will be better understood from studying the detailed description of one entirely nonlimiting exemplary embodiment illustrated by the attached drawings, in which:

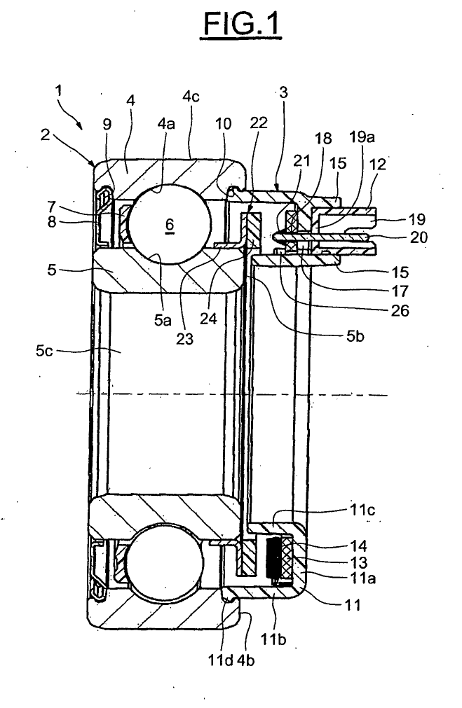

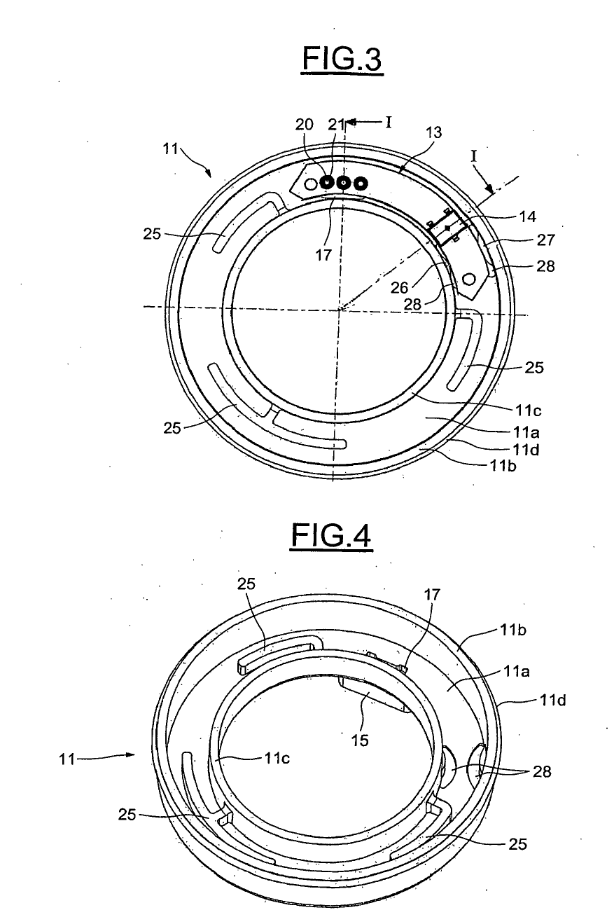

FIG. 1 is a view in axial section on I-I of FIG. 3 of an instrumented rolling bearing;

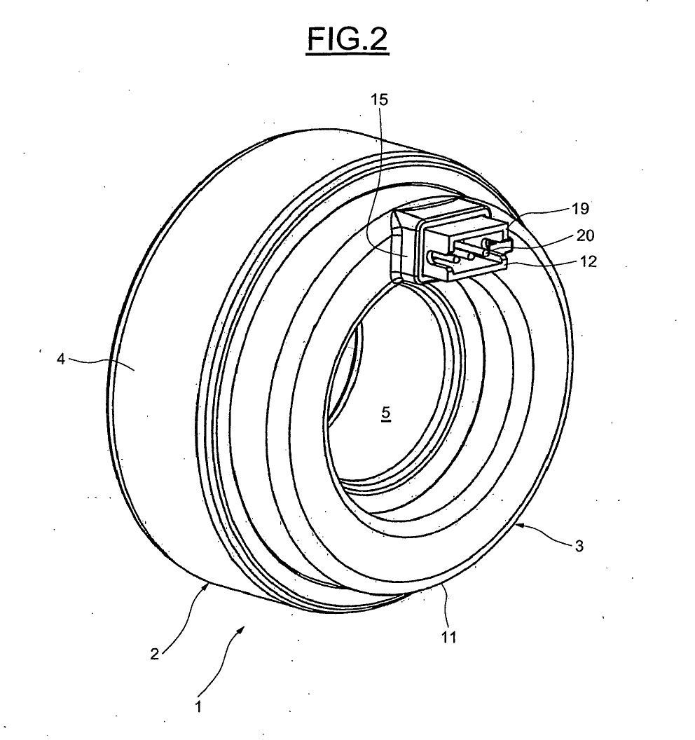

FIG. 2 is a perspective view of the rolling bearing of FIG. 1;

FIG. 3 is a front elevation of the detection assembly of the rolling bearing of FIG. 1;

FIG. 4 is a perspective view of the sensor unit of the detection assembly of the rolling bearing of FIG. 1; and

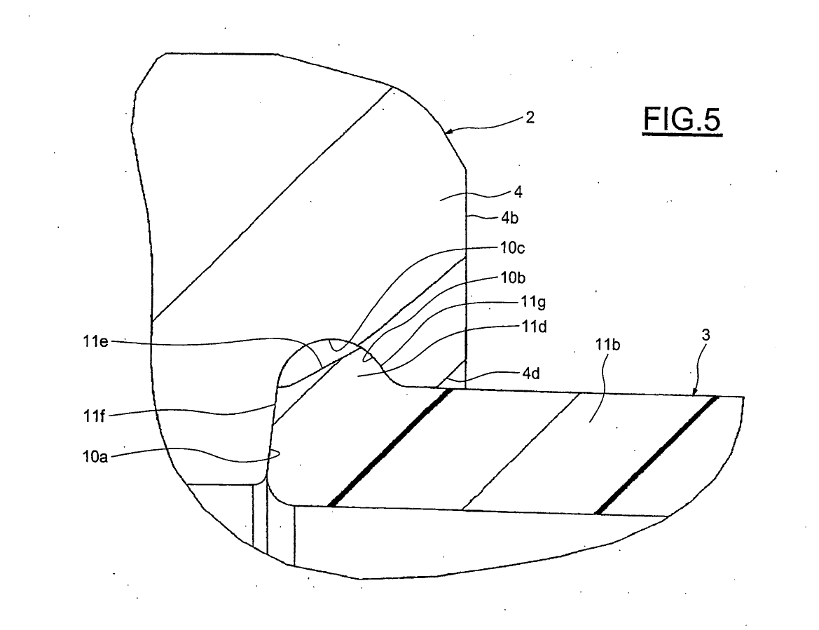

FIG. 5 is a detailed view of the axial section of FIG. 1.

As can be seen in the figures, the instrumented rolling bearing device 1 comprises a rolling bearing 2 and a detection assembly 3 associated with the rolling bearing 2. The rolling bearing 2 comprises an outer ring 4, an inner ring 5, a row of rolling elements 6, in this instance balls, a cage 7 for maintaining the uniform circumferential spacing of the rolling elements 6, and a sealing plate 8 fixed into a groove 9 of the outer ring 4 and forming a narrow passage with an axial land of the inner ring 5.

The rings 4 and 5 each comprise a raceway 4a, 5a respectively on their bore and on their axial exterior surface. The raceways 4a and 5a are of toroidal shape and may be formed by machining a portion of the tube or from an annular blank.

The outer ring 4 also comprises two grooves 9 and 10, near the radial frontal surfaces of said outer ring 4. The grooves 9 and 10 are symmetric with one another with respect to a plane passing through the center of the rolling elements 6.

The rings 4 and 5 are symmetric with respect to a plane passing through the center of the rolling elements 6. Rings 4 and 5 each comprise a frontal radial surface 4b, 5b on the same side as the groove 10. The frontal radial surfaces 4b and 5b are substantially coplanar. On the opposite side, the rings 4 and 5 may also each comprise a frontal radial surface, these surfaces being substantially coplanar. The ring 5 comprises a cylindrical bore 5c and the ring 4 comprises a cylindrical axial exterior surface 4c. The outer ring 4 and the inner ring 5 are concentric.

The detection assembly 3 is fixed into the groove 10 and has an overall radial size smaller than that of the rolling bearing 2. In other words, the detection assembly 3 has an exterior surface of a diameter smaller than that of the exterior surface 4c of the outer ring 4 and a bore of a diameter greater than the bore 5c of the inner ring 5.

The detection assembly 3 comprises a sensor unit 11, a connector and a printed circuit board 13. The sensor unit 11 has an annular overall shape with a C-shaped cross section, one radial branch or portion 11a being positioned between a large-diameter axial portion or branch 11b and a small-diameter axial portion or branch 11c. The small-diameter axial branch 11c has a length shorter than that of the large-diameter axial branch 11b. The large-diameter axial branch 11b is provided at its free end, on its exterior surface, with a bulge or rib 11d, preferably a circumferentially continuous one, projecting into the groove 10 of the outer ring 4 and thus holding the sensor unit 11 in place relative to the outer ring 4, while leaving the radial surface 4b of the ring 4 unencumbered.

In other words, the outside diameter of the large-diameter axial portion 11b is smaller than the inside diameter of the frontal radial surface 4b of the ring 4. The part of the large-diameter portion 11b that lies axially on the outside of the rolling bearing 2 is devoid of any element projecting radially outward. This part thus has an exterior surface that has no roughnesses, i.e. is substantially smooth. Thus, the large-diameter annular axial portion 11b leaves the radial surface 4b of the outer ring 4 completely unencumbered so that this surface can be used as a reference surface and bearing against a shoulder or some other internal radial surface of an associated housing.

To make it easier for the rib 11d to enter the groove 10 of the outer ring 4, said rib 11d is chamfered, the chamfer 11e here being in the form of a frustoconical surface extending inward at an angle smaller or equal to that of a chamfer 4d positioned at one axial end of the ring 4. The chamfer 11e meets an inclined surface 11g of the rib 11d. The chamfer 11e not only makes it easier for the rib 11d to enter the groove 10 but also makes it easier to fit the sensor unit 11 on the non-rotating ring 4. The angle of the chamfer 11e in this instance is of the order of 25°, while the chamfer 4d is at approximately 45°. The angle of the chamfer here means the angle formed by the surface of the chamfer and a surface that runs horizontally, for example the exterior surface of the large-diameter axial portion 11b.

A small-diameter edge of the chamfer 11e of the rib 11d meets a substantially radial frontal surface 11f of the large-diameter axial portion 11b which comes into contact with a substantially radial wall 10a of the groove 10 that is situated axially on the same side as the rolling elements 6. The frontal surface 11f here fully bears axially against the wall 10a of the groove 10. Of course, as an alternative, just part of the frontal surface 11f may bear against said wall 10a. The rib 11d comes into contact with a wall 10b of the groove situated axially on the same side as the chamfer 4d. The walls 10a and 10b converge radially toward a bottom 10c of the groove 10. On the inside of the outer ring 4, the external annular axial portion 11b of the sensor unit 11 therefore engages via frictional contact with the groove 10 via the rib 11d and the radial frontal surface 11f.

Thus, the rib 11d of the large-diameter axial portion 11b interferes with two axially opposed walls 10a and 10b of the groove 10. The sensor unit 11 is axially centered and positioned therefore solely by virtue of the groove 10 of the outer ring 4 of the rolling bearing, without it having also to bear against the radial frontal surface 4b of said ring.

The frontal surface 11f thus forms a thrust surface for the axial positioning of the sensor unit 11 against the groove 10 of the outer ring 4, and the surface 11g forms a retaining surface for retaining the rib 11d inside said groove 10. The thrust frontal surface 11f and the wall 10a of the groove 10, on the one hand, and the retaining surface 11g and the wall 10b of said groove on the other hand, interact with one another in order, through friction, to center the sensor unit 11 and angularly immobilize it inside the groove 10.

In other words, the frontal surface 11f and the retaining surface 11g of the rib 11d form means of holding the sensor unit 11 relative to the ring 4 in the axial, radial and circumferential directions which interact with complementary holding means belonging to said ring and consisting of the walls 10a and 10b.

The small-diameter axial branch 11c forms a narrow passage with the radial frontal face 5b of the inner ring 5. The sensor unit 11 defines an annular space open toward the rolling bearing 2. More specifically, the annular space is delimited by the large-diameter axial portion 11b, the small-diameter axial portion 11c, and the radial portion 11a that connects said portions.

The printed circuit board 13 is positioned in the bottom of said annular space in contact with the radial portion 11a of the sensor unit 11. The printed circuit board 13 supports at least one sensor element 14, for example of the Hall effect type.

The sensor unit 11 further comprises a positioning element 15 intended to collaborate with the connector 12. The positioning element 15 is in the form of a hollow parallelepiped delimiting a rectangular space in which the connector 12 is located. The positioning element 15 projects axially with respect to the radial portion 11a of the sensor unit 11, in the direction away from the rolling bearing 2. The positioning element 15 occupies a limited angular sector, unlike the remainder of the sensor unit 11 which is annular. The positioning element 15 extends axially over a length markedly shorter than that of the connector 12 and serves to guide the connector 12 while it is being fitted. The positioning element 15 thus defines an open housing for the connector 12.

This housing is supplemented by an opening 17 formed through the radial portion 11a of the sensor unit 11 and thus opening into the space in which the printed circuit board 13 is fitted. Holes 18 are provided in the printed circuit board 13 so that they face the opening 17 once the board is in place. The sensor unit 11 can be obtained by injection-molding a synthetic material.

The connector 12 comprises an insulating part 19 and a plurality of conducting pins 20. The insulating part 19 has the overall shape of a rectangular parallelepiped inserted between the positioning element 15 of the sensor unit 11 and in contact with the radial wall 11a. The insulating part 19 is open on its opposite radial face to the radial wall 11a of the sensor unit 11 so as to exhibit a concave region into which an electric plug can be fitted. The pins 20, fixed permanently into a radial bottom wall 19a of the insulating part 19, project on each side of the radial wall 19a of the insulating part 19.

The pins 20 pass through the opening 17 formed in the radial wall 11a and the holes 18 formed in the printed circuit board 13 and project slightly beyond the printed circuit board 13 while at the same time being attached thereto by soldering 21, for example of the soft solder type. The pins 20 of the connector 12 thus form an axial mechanical connection between the insulating part 19 of the connector 12 on one side of the radial wall 11a and the printed circuit board 13 on the other side. The insulating part of the connector 19 and the printed circuit board are therefore kept axially in contact with said radial portion 11a which forms a dividing partition.

Furthermore, an encoder element 22 is fixed to the inner ring 5. More specifically, the encoder element 22 comprises a support 23, for example a sheet metal cup of L-shaped cross section push fitted onto a radial exterior surface of the outer ring 5, on the same side as the detection assembly 3. The support 23 comprises a push-fitted axial portion and a radial portion directed outward from the axial portion. The encoder element 22 is supplemented by an active part 24 fixed, for example by overmolding, onto the radial portion of the support 23. The active part 24 may be in the form of a multi-pole ring, for example made of plasto ferrite. The active part 24 projects slightly in the axial direction with respect to the inner ring 5 and is positioned radially in the space delimited by the large-diameter 11b and small-diameter 11c axial portions of the sensor unit 11. The active part 24 is separated from the sensor 14 by a small axial air gap. The encoder 22 leaves the radial surface 5b of the ring 5 unencumbered.

By way of an alternative, it might be possible to provide a radial air gap with a sensor 14 positioned on the inside or on the outside of the active part 24.

As may be seen in FIG. 3, the printed circuit board 13 occupies a limited angular sector of the annular space defined by the sensor unit 11. It is desirable for the printed circuit board 13 to be guided angularly with respect to the sensor unit 11 at the time of fitting. The sensor unit 11 comprises a plurality of ribs 25 projecting radially with respect to the internal face of the radial portion 11a, or in other words projecting toward the rolling bearing 2. The ribs 25 may have portions in the form of circular arcs and/or radial or alternatively oblique portions. The ribs 25 leave just enough angular space in which to house the integrated circuit board 13.

In the example illustrated in FIGS. 3 and 4, the ribs 25 are connected by short radial portions to the small-diameter axial portion 11c and thus play a part in stiffening. The ribs 25 are also able to improve the rigidity of the radial portion 11a. The ribs 25 both stiffen the sensor unit 11 in its entirety and play a part in the coarse angular positioning of the integrated circuit board 13.

In the embodiment illustrated in FIGS. 3 and 4, the ribs 25 are three in number and leave between them two small angular sectors that are not large enough to accommodate the integrated circuit board 13 and a larger angular sector slightly bigger than the space needed for the printed circuit board 13. This simplifies the angular positioning of the printed circuit board 13, whether this be done automatically or by hand.

Furthermore, the sensor unit 11 comprises two studs 26 and 27 projecting radially toward the outside and toward the inside respectively, from the small-diameter axial portion 11c and the large-diameter axial portion 11b. These studs 26 and 27 are in the form of a slightly projected rounded boss which thus locally reduces the amount of radial space available for inserting the printed circuit board 13. Specifically, the studs 26 and 27 are positioned facing one another in the angular sector designed to accommodate the printed circuit board 13. The studs 26 and 27 extend axially over part of the axial length of the axial portions 11b and 11c.

To promote a certain degree of radial elasticity of said axial portions 11b and 11c at the sites of the studs 26 and 27, two localized arcuate or arrowhead openings 28 are formed in the radial portion 11a, angularly in the vicinity of the studs 26 and 27. Locally, the axial portions 11b and 11c thus have a markedly higher radial elasticity, allowing the studs 26 and 27 to part slightly as the printed circuit board 13 is inserted in an axial movement as it is being fitted, then return to their original position, thus holding the printed circuit board 13 in place while it is being fitted and before it is soldered.

The connector 12 may be assembled with the sensor unit 11 before or after the pre-assembly of the printed circuit board 13, and can be held temporarily in position by the positioning element 15 which, through its shape, has a very small amount of flexibility allowing it to exert enough friction on the insulating part 19 of the connector 12. The spots of solder 21 may then be created, while at the same time clamping the connector 12 and the integrated circuit board 13 lightly against the radial wall 11a which forms a dividing partition between these elements. Once the soldering has been done, the detection assembly 3 is in the form of a system that cannot be dismantled and has a particularly low risk of loss of parts.

As may be seen from FIGS. 3 and 4, the hole 17 through which the pins 20 can pass through the radial portion 11a is angularly offset from the studs 26 and 27 and from the openings 28, this making it possible, on the one hand, to avoid excessive weakening of the sensor unit 11 that would be caused if the drilling 17 and the openings 28 all of which are formed in the radial wall 11a were too close together and, on the other hand, to provide effective retention of the integrated circuit board 13 which has a certain angular size and which is held axially at one end by the solder connections 21 and at the other end by the studs 26 and 27. This then prevents excessive torsional forces from being applied to the printed circuit board 13.

The soldered joints 21 and the pins 20 have a dual role of providing electrical connection for transmitting signals from the sensor 14 or from an electronic processing circuit, on the one hand, and of providing mechanical connection on the other hand, in order to hold the connector 12, the sensor unit 11 and the printed circuit board 13 together.

Use may be made of standard connectors that are mass produced in great numbers and therefore at low cost. The printed circuit board may also suit various sizes of standard rolling bearings. Only the sensor unit is tailored to the size of the bearing. The detection assembly is well suited to the use of conventional rolling bearings of the deep-groove single row ball bearing type, using the groove 10 of the rolling bearing 2 that was initially intended for fitting a seal. The bulge or rib 11d, used to fix the sensor unit 11 to the groove 10 of the outer ring, can be obtained by molding, and this can be done relatively economically. The sensor unit 11 can be axially positioned and centered solely using the groove 10 of the outer ring 4 of the bearing. The instrumented rolling bearing is radially very compact and can easily be inserted into a housing.

Furthermore, the sensor unit 11 leaves the radial surface 4b of the outer ring 4 completely unencumbered so that this surface can be used as a reference face and bear against a shoulder or some other internal radial surface of the housing.

In other words, the frontal radial surface 4b of the outer ring 4, which is substantially coplanar with the radial surface 5b of the inner ring 5, remains unencumbered. The sensor unit allows accurate positioning of the attached connector by virtue of the projecting housing formed on the exterior frontal surface of the sensor unit.

Furthermore, because the large-diameter axial portion 11b consists of an annular thin wall of relatively long axial dimension, for example of the order of half the axial dimension of the rolling bearing 2, this wall can easily be deformed radially inward, making it easier to fit the rib 11d into the groove 10.

Furthermore, once the rib 11d has been fitted inside the groove 10, the large-diameter annular axial portion 11b tends to move outward, and center itself on the large-diameter portion of the stepped bore of the outer ring 4. The rib 11d is thus radially preloaded against the groove 10, making it possible locally to form a sealed connection between the sensor unit 11 and the outer ring 4.

By virtue of this sealed connection and of the axial positioning of the small-diameter axial portion 11c relative to the radial frontal surface 5b, the annular space in which the printed circuit board 13, the sensor 14 and the encoder element 22 are mounted is more or less sealed. Ingress of any contaminants is therefore limited.

Advantageously, a polybutylene tetraphthalate (PBT), for example one filled with glass fibers or carbon fibers, for example to a content of 30%, is used to manufacture the sensor unit 11. This material offers both good stability against the absorption of moisture and good frictional adhesion to steel, promoting effective attachment of the sensor unit 11 in the groove 10, even in circumferential direction.

When a female-type plug is inserted into the connector 12, it is possible, without significant risk, to apply a substantial axial force, said force being reacted by the radial partition 11a of the sensor unit 11 against which the connector bears. When the female-type plug is withdrawn, the soldered joints transmit the axial force to the integrated circuit board which bears against the radial partition of the sensor unit. The integrated circuit board therefore remains perfectly axially positioned with very small risk that the size of the air gap between the sensor or sensors and the encoder ring will vary, such variations in the size of the air gap being liable to affect the reliability of the measurements. Furthermore, the sensors are suitably protected by the sensor unit and by the narrow passage formed with the inner ring.

The invention provides an instrumented rolling bearing provided with at least one means of generating a friction force which through collaboration with the groove allows the sensor unit to be centered and axially positioned relative to the outer ring in such a way as to leave a frontal radial surface of the outer ring completely unencumbered so that it can bear entirely against a shoulder of the housing associated with the rolling bearing.

1. An instrumented rolling bearing device comprising:
a rotating ring,
a non-rotating ring, and
a detection assembly with a sensor unit including an external annular portion and a means of axially retaining the sensor unit on the non-rotating ring, the axial retention means being positioned on the external annular portion, and the outside diameter of the external annular portion being smaller than the inside diameter of a frontal radial surface of the non-rotating ring.

2. The device as claimed in claim 1, in which the non-rotating ring has a groove and the means of axial retention includes a circumferentially continuous radial rib disposable within the groove of the non-rotating ring.

3. The device as claimed in claim 2, in which the groove has an entry chamfer and the rib is chamfered at an angle, the rib chamfer angle having a value one of lesser than and equal to that of an angle of the groove entry chamfer.

4. The device as claimed in claim 2, in which the external annular portion includes a frontal surface, at least part of the frontal surface being in frictional contact with the groove, and a retaining surface, at least part of the retaining surface being in frictional contact with the groove, said retaining surface and said frontal surface forming means of holding the sensor unit in position relative to the non-rotating ring.

5. The device as claimed in claim 2, in which the sensor unit includes an internal annular portion, the internal annular portion forming a narrow passage with a frontal radial surface of the rotating ring, and with a radial portion positioned between the internal annular portion and the external annular portion, the rib, the radial portion and the internal and external annular portions defining a sealed annular space for a sensor.

6. The device as claimed in claim 2, in which the non-rotating ring includes an additional groove substantially identical to the groove associated with the rib and a sealing plate mounted in the additional groove.

7. The device as claimed in claim 1, in which the sensor unit (11) includes at least one positioning element and a connector mounted inside the positioning element, the positioning element extending axially with respect to a radial portion of the sensor unit, in the direction away from the rings.

8. The device as claimed in claim 7, in which the positioning element has an outside diameter smaller than the inside diameter of the frontal radial surface of the non-rotating ring.

9. The device as claimed in claim 7, in which the sensor unit includes a printed circuit board, a radial portion of said sensor unit forming a partition being positioned between the connector and the printed circuit board.

10. The device as claimed in claim 1, in which the sensor unit is made of polybutylene tetraphthalate.

11. The device as claimed in claim 11, in which the sensor unit is made of polybutylene tetraphthalate filled with mineral fibers.
